(19) United States
(12) Patent Application Publication
(10) Pub. No.: US 2009/0206573 A1
(43) Pub. Date: Aug. 20, 2009

(54) Variable-length control arm

(76) Inventor: Forrest Derry Merryman, Bellaire, OH (US)

Correspondence Address: Forrest D. Merryman, 56801 High Ridge Road, Bellaire, OH, 43906, US

(21) Appl. No.: 12/069,888

(22) Filed: Feb. 14, 2008

(51) Int. Cl. B60G 7/00

(52) U.S. Cl. 280/124.134

(57) ABSTRACT

Before, vehicles with independent suspensions could not alter the tire's positions. Modifications or use of aftermarket parts were needed for the vehicle to perform under more extreme conditions such as gaining clearance for off road use or squatting down low for a wide, racy stance. My invention will allow many scenarios of suspension types to be used on a single vehicle, with a single suspension system. The control arms are fixable in length allowing many variances in ride height, stance and wheelbase. This will broaden the vehicle's purpose and capabilities and will make many aftermarket upgrades to the vehicle unnecessary.

### CROSS-REFERENCE TO RELATED APPLICATIONS

Not Applicable

### FEDERALLY SPONSORED RESEARCH

No aid of sponsorship of any kind was used.

### SEQUENCE LISTING OR PROGRAM

Not Applicable

### BACKGROUND OF THE INVENTION

1. Field of Invention

This invention relates to an improvement on vehicles' independent suspension systems, specifically allowing a vehicle's undercarriage to convert between two or more scenarios of suspension and drive train desirable for its needed capabilities.

2. Prior Art

Recreational vehicles, meant to be the most capable off of paved roads, are often limited to trucks and sport-utility vehicles. These vehicles have been engineered by their manufacturers first and foremost to handle safely on the road while having their limited off-road capability for recreation. They employ four wheel or all wheel drive using the following: solid axles with a leaf spring suspension, free axles with independent suspension, or a front and rear combination of both. The setups' capabilities are well rounded, thus achieving mediocre performances in more than one field of use. However, these setups, again, are designed mainly for road use. Only to an extent do they provide for articulation, ground clearance, and ability to house larger tires.

To allow for the described articulation, ground clearance, and ability to house larger tires, aftermarket manufacturers advertise multiple ways to crudely raise the ride height of a vehicle. Most vehicles, regardless of suspension type, may be lifted with body lifts. This raises the chassis higher from the frame; therefore, it is a less functional modification and is only suitable for certain vehicles. Improving the characteristics of suspension for the solid axle include installing lift blocks, alternate leaf springs, or relocating the axle below the leaf springs. Vehicles using independent suspension systems must replace many parts of the drive train and suspension with aftermarket manufacturer's parts to achieve greater performance.

All of these altercations and many more like them improve recreational capabilities only. They require the altered vehicles to be best capable in off-road use and limited in road use; therefore, making the vehicle permanently dangerous on public roads. The additional lift increases the vehicle's bumper height, adding risk to other lower vehicles which may have a collision with the lifted vehicle. Also, the lifted vehicle's center of gravity is raised, making the vehicle more liable to overturn. Lastly, the altercations go against many manufacturers' warranties, reinforcing the idea that the oversized vehicles are not safe to operate on public roads.

This functionality problem arises when people have a desire for improved off road capabilities. They either modify their personal vehicles or utilize a preexisting chassis for off road use; these are also known as “trail rigs.” These methods require much more labor and are not cost effective. To modify a commonly used vehicle is expensive and voids many warranties. To use another chassis provides for a seemingly easier solution. The sacrificed chassis is able to be radically fabricated for its more specific use. Likewise, if this vehicle should become damaged, it must be set aside or discarded for it is not needed for an everyday commute. However, more space is needed to store the vehicle. If this class of vehicles is driven on public roads to its recreation site, they require insurance. If the vehicle is illegal to be driven on the road, a proper trailer must be used.

Many problems arise when the vehicle's owner requires improved recreational capabilities off of the paved road. These ways to improve ride height, articulation, and the application of larger tires for recreational purposes provide for many disadvantages of everyday use:
1. The altercations described above limit the safe use of the vehicle to only off of the road at slower speeds. The vehicle's capability is not nearly as safe as the manufacturer's engineered use on public roads. Reasons include:
   A. The increased center of gravity makes the altered vehicle more liable to overturn at increased speeds.
   B. The increased ride height makes the altered vehicle's higher bumper height a clear and present danger for smaller vehicles such as family cars and vans.
   C. The increased ride height causes smaller vehicles to be dangerously hidden in blind spots in the more frequently use on roads.
2. The altercations of the parts of the vehicles provide for many difficulties in value of the vehicle and provide for many costs. Reasons include:
   A. Moderate to extreme altercations made to a vehicle are not cost effective due to the price of the replacement parts and the added effort of the installation.
   B. An altered vehicle is difficult to restore to its original condition and value since these needed fabrications and parts are designed to be more permanent and survive the extended use.
   C. The altercations made specifically to the suspension and drive train of a vehicle void many warranties provided for by the manufacturers of the vehicles, discouraging recreation.

3. Objects and Advantages

My invention provides a solution for one to obtain both excelled safety and added capabilities on and off of paved roads. Although not limited to the following, objects and advantages achieved with my invention are:
(a) to provide a method for a vehicle's undercarriage to superbly be proficient on and off the road, as from the manufacturer, with no, limited, or extensive applications of replacement parts from aftermarket suppliers;
(b) to provide a method for a vehicle's undercarriage to seamlessly convert between two or more settings of suspension and drive train desirable for its needed capabilities;
(c) to provide a method for a vehicle's undercarriage to not be restricted and allow variance in the vehicle's ride height, stance, and articulation desirable for its needed capabilities;
(d) to provide a method for a vehicle's undercarriage to, at varied settings, allow for more suitable wheels and tires without issues of fender, frame, or wheel well clearance;
(e) and to provide a method for a vehicle's undercarriage to be manufactured and warranted for a sizeable market allowing for increased recreational opportunities and capabilities.

Further objects and advantages of my invention will become apparent from a consideration of the drawings and ensuing descriptions.

### SUMMARY

My invention solves the many problems people face when they want there everyday vehicle to have excelled performances in road, off road, or even race use. My invention pertains to the way a vehicle varies the properties of its suspension and drive train to have many specific capabilities in more than one field of use. My invention attains increased capabilities in:

1. Highway Use.
a. Desirable lower ride height for improved safety.
b. Road worthy suspension for cornering and rapid changes of speed.
c. Allowing for tires best suitable for use on paved roads.
d. Having a typical stance for road use.

2. Off Road Use.
a. Added articulation for maneuvering over obstacles.
b. Greater stance for added stability.
c. Allowing application for more suitable wheels and tires.

3. Track Use
a. Optimum ride height for best placement of weight on the wheels.
b. Tunable suspension for less body roll and improved cornering and handling.
c. Always allowing the use of tires best utilized for race tracks, dirt or paved.
d. Having a wider stance.

### DRAWINGS—FIGURES

The following drawings are presented as my preferred use of my invention; however, other embodiments of my invention can be used to better achieve desirable objects and advantages not just stated but also interpreted. The following figures (figs) are merely suggestions intended to give the reader a better understanding of my invention and more importantly the various processes it may achieves. The figures depict multiple vehicles and their supporting frame, suspensions and drive train.

FIG. 1 very vaguely depicts two vehicles from the superior and frontal view. Object 1-A represents a vehicle from its top view. Object 1-B represents the same vehicle with its control arms in their expanded form. Objects 1-C and 1-D represent the two vehicles from their front view. The figure's purpose is to show how the varying control arm length alters the suspension's characteristics. The exaggerated control arms' size provides for a larger stance, identical wheel base, and vastly improved articulation capabilities.

FIG. 2 also very vaguely depicts two vehicles from the superior and frontal view. Object 2-A represents a vehicle from its top view. Object 2-B represents the same vehicle with its control arms in their expanded form. Objects 2-C and 2-D represent the two vehicles from their front view. The expansion of the control arms moves the tire location laterally away from the vehicle and increases tire distance and vehicle height. The expansion of the control arms gives the vehicle a larger stance and larger wheel base.

FIG. 3 shows two objects resembling control arms. The two objects are the same piece; however, they are presented in different forms. Object 3-A resembles the control arm in its collapsed form. Object 3-B is the same piece in its expanded form. The expansion moves the tire placement away from the vehicle.

FIG. 4 is a more detailed representation of the first figure and utilizes the object in FIG. 3. Object 4-A resembles a vehicle using the variable-length control arms in their contracted configuration. Object 4-B resembles the same vehicle using the control arms in their expanded configuration, achieving greater ride height and stance.

FIG. 5 shows two objects resembling control arms. The two objects are the same piece; however, they are presented in different forms. Object 5-A resembles the control arm in its collapsed form. Object 5-B is the same piece in its expanded form. The expansion moves the tire placement laterally and increases the vehicle's wheelbase.

FIG. 6 is a more detailed representation of the second figure and utilizes the object in FIG. 5. Object 6-A resembles a vehicle using the variable-length control arm in their contracted configuration. Object 6-B resembles the same vehicle using the control arms in their expanded configuration, achieving greater ride height, stance, and wheelbase of the vehicle.

FIG. 7 is another more detailed depiction of FIG. 2 in that the expansion increases the vehicle's stance and wheelbase. Though resembling FIG. 6, it has two pivot arms moved by hydraulics. It shows two of the stages, fully contracted and full extended (Object 7-A and Object 7-B, respectively).

FIG. 8 is another preferred embodiment of my invention. The method of expansion moves parallel to the frame and simplifies the overall design. The method of expansion will later be defined in the detailed description of the invention. Object 8-A shows use of the pivot arms before the expansion; Object 8-B shows use of the pivot arms in there relocated position after the expansion. The wheelbase does not increase but the vehicle's stance and ride height increases.

FIG. 9 is much like FIG. 8, but the two stages relocate the tires away from the vehicle and the wheelbase is increased. Object 9-A is before the expansion; Object 9-B is fully expanded. Again, like FIG. 8, the method of expansion runs along the length of the body.

### DESCRIPTION OF INVENTION

In the past, the only way a vehicle could change to better accommodate its passengers through the environment was to change between two-wheel, four-wheel, or all-wheel drive. Not only does my invention allow for changing the way power is distributed to the wheels, but also allowing that vehicle to alter properties of its suspension to better handle the many environments. This invention can be utilized by all sorts of vehicles, from remote-controlled toys all the way to full-size vehicles found on the road.

The invention relates to the idea of expansion and contraction. Like many industrial vehicles like tractors and dump trucks, this expansion may be powered by hydraulics. Many other methods of expansion may be used, such as rotational movement, or other means of manual change.

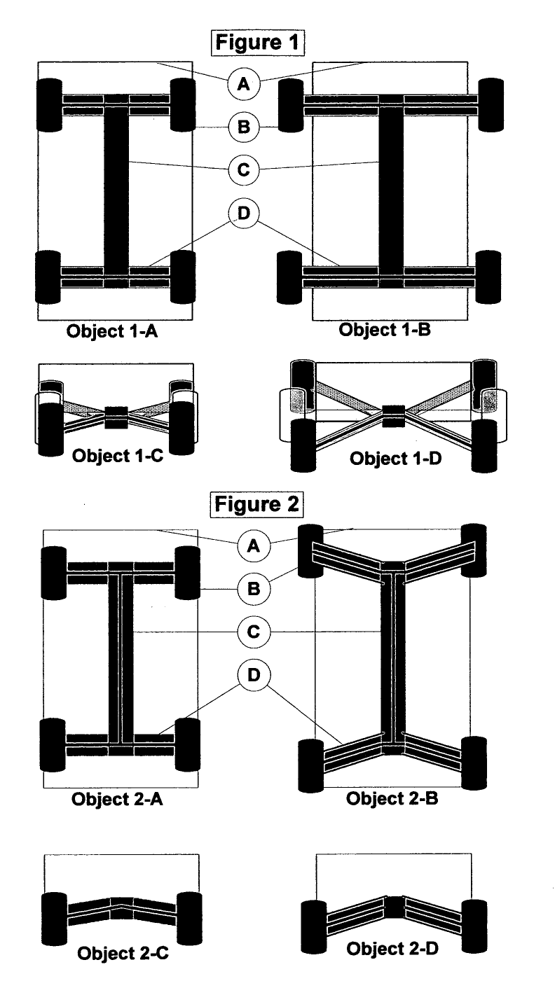

FIGS. 1 and 2 vaguely depict two vehicles that undergo changes. The vehicle on the right lengthens its control arms' lengths and changes its tire placement. FIG. 1 shows how relocating the tires further away from the vehicle increases its stance, and allows for greater wheel travel. This increased wheel travel allows for changeable ride height and articulation.

FIG. 2 shows a vehicle repositioning the its tires away from the center but even increases the vehicle's wheelbase by moving the tires towards the front and rear of the vehicle. This new tire location also provides for a greater approach and departure angle as well as the increased ride height, articulation, and vehicle stance. Although these dimensions are not scale, this shows there is a 25% increase in the vehicle's wheelbase, and at this current ride height there is a 20% increase in the vehicle's stance. More detailed depictions of these processes will follow.

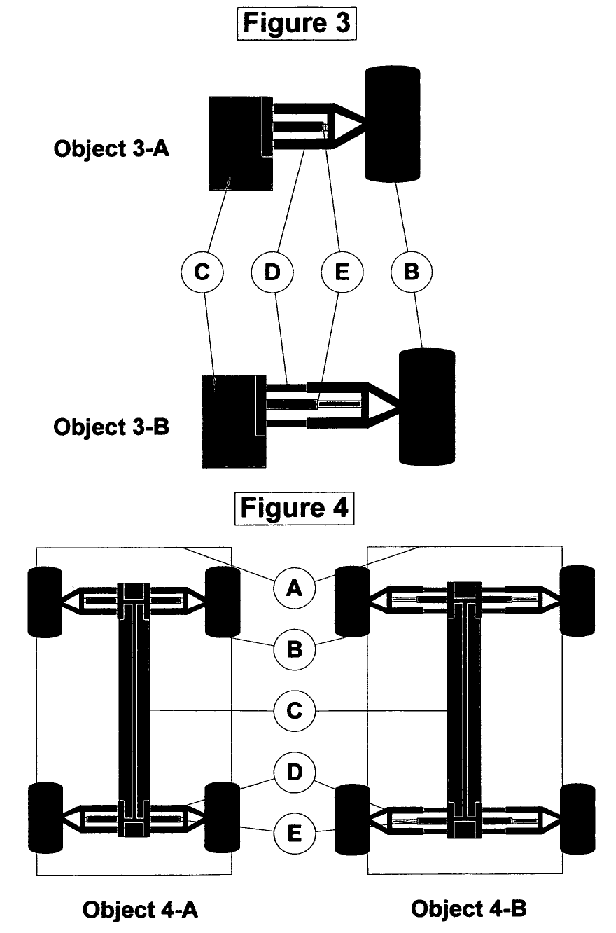

FIG. 3 shows one way how a vehicle's control arm can be expanded to a greater length. FIG. 4 shows a vehicle using this variable-length control arm to allow for greater ride height, articulation, and stance in a vehicle. This relocation of the tire allows for use of larger tires more capable for extreme terrains. Here, my preferred embodiment, the expansion is caused by the hydraulic piston that can be powered by the vehicle, or an external power source.

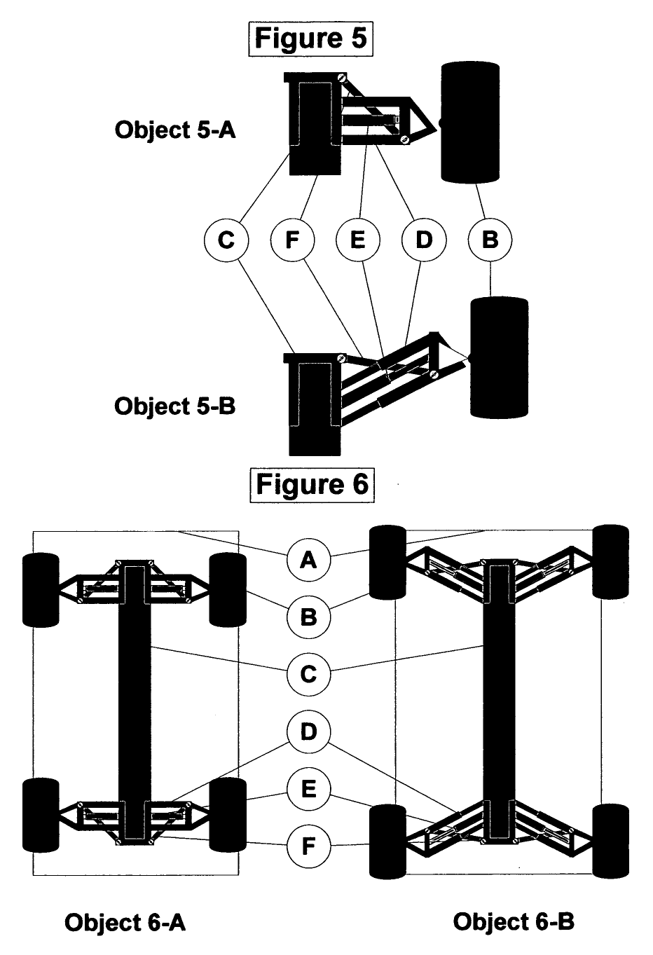

FIG. 5 shows how a vehicle's control arm can be expanded to a greater length, but at the same time, move towards the front and rear of the vehicle. Using the pivot arm (F), the expansion swings the tire location, increasing the vehicle's wheelbase. FIG. 6 shows how a vehicle utilizes this expansion. It demonstrates how the object of FIG. 5 provides for a greater approach and departure angle as well as the increased ride height, articulation, and vehicle stance.

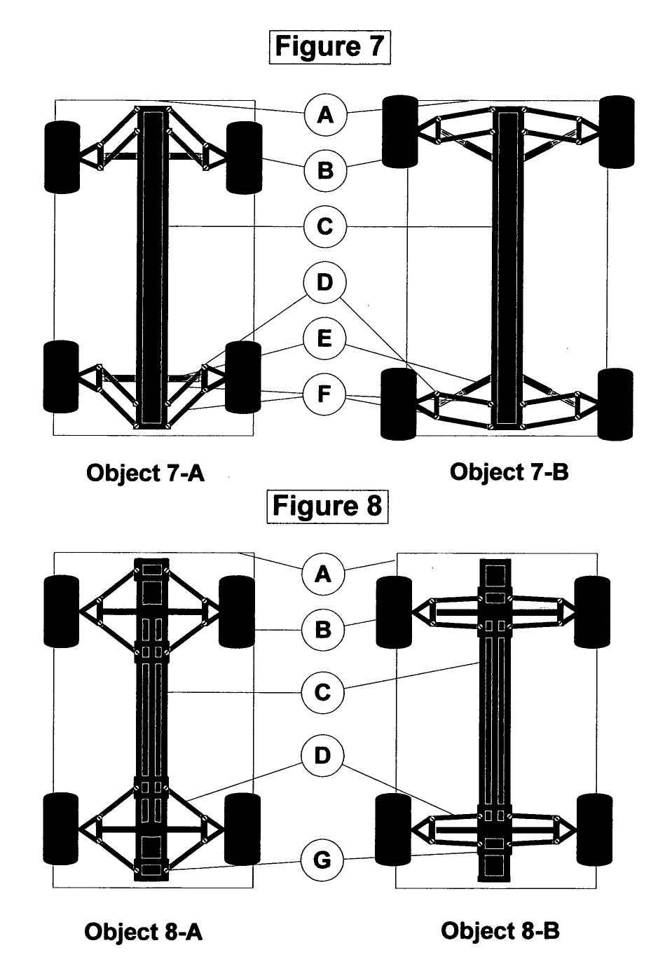

FIG. 7 is much like FIG. 6, only it uses pairs of pivot arms controlled by a hydraulic piston. It is another variance of the preferred embodiments and demonstrates how all of these figures can be further varied.

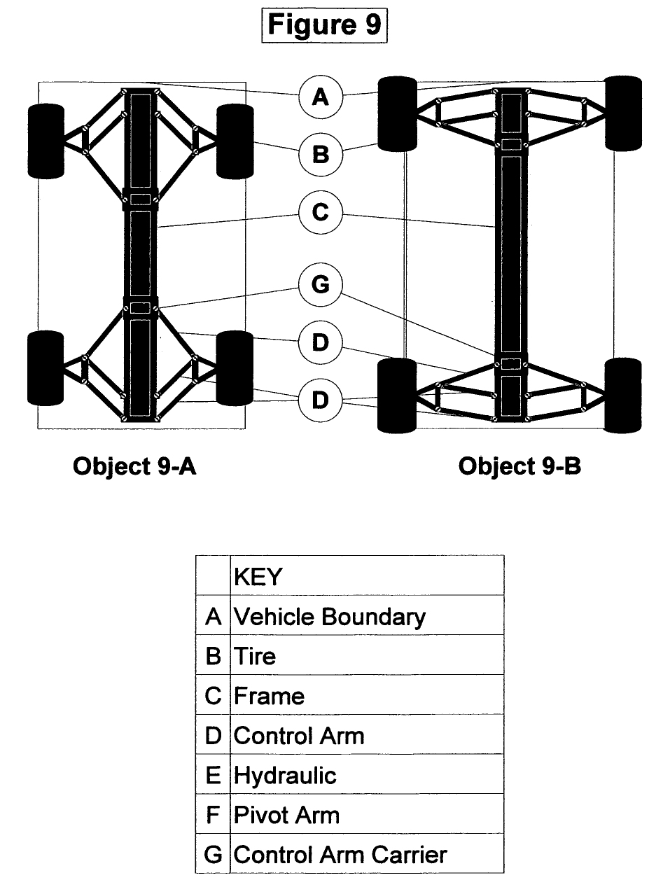

FIGS. 8 and 9 show how method of expansion can occur parallel to the vehicle's longitudinal axis. The control arm carrier moves along a frame and may be attached by using a track-like attachment. The carrier may move along this track by using hydraulic pressure, a rotational force from the engine, or by another manual means. FIG. 8 moves the tires laterally away from the vehicle while FIG. 9 also increases the longitude distance between the tires.

All of these embodiments, like all vehicles found today, may use parts made of machined metals.

This is the first improvement of its kind made to the control arms of vehicles using independent suspensions. Never before has the control arm's length been adjustable in this way. This variance in the control arm will allow a vehicle to actively adapt to a changing environment, such as street, off road, and race purpose use. This can allow for better articulation, increased stance and wheel base, and adjusting the ride height to better perform in many scenarios. The figures mostly show a great amount of tire relocation; however, subtle effects can be made such as to tune a street vehicle to squat lower to the ground.

I claim:

1. A control arm for a suspension system for a vehicle having a plurality of wheels which connects the chassis/frame to the wheels.

2. A supporting control arm which comprises features of the regular a-arm such as driveline, steering, and support while allowing the control arm to expand and contract when needed.

3. A control arm which may change the location of the vehicle's tires laterally, lengthwise, and/or vertically.

4. A control arm, as described in claim 3, which may vary a vehicle's ride height, stance, and/or wheelbase.

5. A control arm, which relocates the tires' positions, is allocated by a force that may or may not be powered by the vehicle itself comprising methods such as hydraulic, rotational force, and/or other means of manual force.
